(19) United States
(12) Patent Application Publication
(10) Pub. No.: US 2008/0078271 A1
(43) Pub. Date: Apr. 3, 2008

(54) Tattoo machine

(76) Inventor: Mitchell Atkinson, Helen, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/541,942

(22) Filed: Oct. 2, 2006

(51) Int. Cl. B43K 5/00

(52) U.S. Cl. 81/9.22

(57) ABSTRACT

A tattooing device for tattooing transdermal images includes a removable circuit board carrying the electronic components of the tattooing device, facilitating cleaning of the tattooing device. The tattooing device is adjustable to vary the speed of reciprocation of the needle and to vary the force with which the needle is driven. The tattooing apparatus also includes decorative accessories that can be attached to the tattooing device to personalize the appearance of the tattooing device in order to facilitate identification of a particular tattooing device among many. The accessories may also convert the tattooing device into a toy car or motorcycle.

### TECHNICAL FIELD

The present invention relates generally to means for permanent ink application to the body, and more specifically, to a method and apparatus for injecting pigment beneath the skin to create a tattoo.

### BACKGROUND OF THE INVENTION

Once thought of as a taboo art form, in recent years, tattooing has become increasingly accepted-as a meaningful art form. Along with the increased acceptance, the cross-sections of society getting tattoos have expanded and the number of tattoo parlors has increased dramatically to satisfy the growing demand for tattoos.

The art of tattooing has grown from its early stages, wherein black markings indicated a tribal association, to the present day, wherein tattoos take on colorful and intricate designs of personal expression. Tattooing has also spread into the cosmetic arena, with an increasing number of women tattooing permanent makeup onto parts of their body, including the lips, eyelids, and eyebrows.

Tattoo machines in use today have remained relatively unchanged for many years. One of the first patents for a tattoo machine, U.S. Pat. No. 196,747, was granted to Thomas A. Edison in 1877. Edison's design introduced the use of electromagnets to cause a needle to reciprocate. When the electromagnetic field was absent, the needle was drawn into an ink chamber through the use of spring tension. When the electromagnetic field was present, the electromagnetic force moved the needle down through the chamber and into the skin.

The next major leap for tattoo machine design, and the design most used today, is a design that provided for the ability to remove and sterilize the needle of the tattoo machine without necessitating realignment of the needle upon reinstallation. Such designs have certain limitations with respect to sterilization, namely, that only the needle portion is readily removable from the machine for disinfection thereof. It is not unusual, however, and is quite common, in fact, for the puncture of the skin to cause blood to spray onto the frame of the tattoo machine, thus potentially contaminating not only the needle., but other machine components as well. The tattoo artist is then forced to tediously dissemble the remaining contaminated portions of the tattoo machine in order to fully sterilize or disinfect the machine. That is, it is necessary to dissemble the entire machine, as blood or other contaminants may be present in otherwise inaccessible voids.

Presently available machines having a readily removable needle assembly do not include body components that can be quickly and easily removed and reinstalled. Further, even if time consuming disassembly is undertaken, only the metal frame can withstand repeated sterilization, wherein electrical components suffer from severe degradation if sterilized or disinfected even once due to their delicate nature. As such, the electrical components may become a significant source of contamination.

A further disadvantage of presently available machines is that if the electrical components require replacement, a full disassembly of the entire tattoo machine is necessary. The need for such replacement is not uncommon, as the components frequently become contaminated and certain components, such as the contact screw and contact spring, are often compromised by carbon buildup. Thus, current tattoo machines have the further disadvantage in that if electrical components, which are present near the center of the machine, need to be changed out, the outer components that block access to the inner components must be removed. This requires a significant amount of time and effort, and is further problematic if the parts are not reassembled in the correct manner.

A commonly used method to attempt to avoid the potential for contamination, and thereby overcome the need for disassembly, is to wrap the machine in plastic. Despite generally protecting the machine, the plastic barrier does little to protect the person receiving a tattoo. That is, droplets of blood sprayed onto the plastic, which is likely to be non-sterile, can collect and fall back onto the person receiving the tattoo, whereby the blood may come in contact with a contaminated material, such as the plastic, and then possibly fall back onto the tattoo site, thus increasing the risk of infection.

Another disadvantage of known tattoo machines is the limitation in the type of lines or shading that can be applied by the tattooist. Typical tattoo machines have two basic modes of operation: lining and shading. Lining operation provides for well-defined lines that are used to either outline a design or to provide for separation from one design portion to the next. Shading operation provides for filling-in the color between the separation lines.

Modern tattoo machines nonetheless provide for some degree of freedom when set to either a shading or lining operation. That is, in a lining operation, some measure of manipulation of the machine can change the appearance of a line. In much the same manner, the typical machine also enables some degree of manipulation to provide for varying types of shading. One major disadvantage in present tattoo machines, however, is that there is no effective means to change the machine operation from lining to shading without significant alteration of the machine's electrical and mechanical components. That is, to change from lining to shading operation, typically the capacitors located on the machine need to be changed to a difference inductance. Other methods presently utilized for changing a tattoo machine from lining to shading, or vice-versa, include changing the needle, and/or manipulating the biasing springs that provide the upward force to the needle when the magnetic field is not present. Each of these methods is time-consuming and tedious.

An additional limitation found in present tattoo machines is the limited potential for customization of the machine's appearance or performance. As is well known in the industry, every skilled tattooist develops their own method and style of tattooing. However, the construction of current tattoo machines does not readily provide for customization of the construction of the machine, neither for utilitarian purposes, nor for aesthetic reasons. Rather, if the tattooist wishes to customize their tattoo machine, the tattooist is limited to stickers or other superficial decorations.

Therefore, it would be beneficial to have a tattoo machine that overcomes the limitations of the prior art, namely, a tattoo machine that can be fully sterilized or disinfected, that provides for easy removal and installation of electrical components, that allows the user to change from lining to shading operation without disassembly, and that provides a platform upon which tattoo artists can customize their equipment beyond superficial ornamentation.

### BRIEF SUGARY OF THE INVENTION

Briefly described, in a preferred embodiment, the present invention overcomes the above-mentioned disadvantages and meets the recognized need for such a device by providing an improved apparatus and method of modifying and reconfiguring a tattoo machine, wherein the present invention functions to provide a means for quickly removing the electrical assembly, and for manipulating the electrical and mechanical settings to change the tattoo machine from a liner to shader, to provide a platform upon which the tattoo artist can customize their tattoo machine, and to provide a means in which the tattoo machine can be quickly disassembled for cleaning, disinfecting and/or sterilizing.

These advantages of the present invention are preferably attained by providing an improved tattoo machine comprising a core frame upon which various functional and decorative components can be mounted, and a removable electronic coil clip that comprises the electrical components.

According to one aspect of the present invention, a preferred tattooing apparatus comprises a frame assembly with a channel circuit attached thereto, a removable coil clip assembly adapted to engage the channel circuit, and a spring loaded trigger adapted to selectively retain the coil clip engaged with the channel circuit, whereby operation of the spring loaded trigger releases the removable coil clip from engagement with the channel circuit such that the removable coil clip can be removed from the tattooing apparatus.

According to another aspect of the present invention, the tattooing apparatus comprises a tuner, such as a tuning screw, operatively connected to the removable coil clip assembly, wherein the tuner facilitates selective adjustment of the speed of reciprocation of a needle of the tattooing apparatus.

According to another aspect of the present invention, the tattooing apparatus comprises an armature bar adjustably connected to the frame assembly and operatively connected to a needle of the tattooing apparatus, wherein the armature bar facilitates selective adjustment of the driving force of a needle of the tattooing apparatus.

According to yet another aspect of the present invention, a method of disinfecting a tattooing apparatus is provided comprising the steps of 1) operating a trigger of the tattooing apparatus in a first state to release the coil clip assembly from the channel circuit of the tattooing apparatus, 2) removing the removable coil clip assembly from the channel circuit, thereby physically decoupling the removable coil clip assembly from the tattooing apparatus and placing the tattooing apparatus in a second state, 3) disinfecting the tattooing apparatus in the second state, and 4) replacing the coil clip assembly from in the channel circuit, thereby physically coupling the coil clip assembly with the tattooing apparatus and replacing the tattooing apparatus in the first state.

According to yet another aspect of the present invention, a tattooing apparatus comprises a frame assembly, front end accessories attached to the frame assembly, and rear end accessories attached to the frame assembly, wherein the front end accessories and the rear end accessories give the tattooing apparatus an appearance of a vehicle, such as a car or a motorcycle, or other user-selected recognizable object, or the like.

In a preferred embodiment of the present invention, the core frame acts as a mounting platform upon which various components may be mounted, to either facilitate performance of a tattoo function or to create a decorative fascia that the user can tailor to their wishes. The core frame preferably has two side plates attached to a base plate such that the bottoms of the side plates are stabilized by the base plate. Furthermore, the tops of the side plates are stabilized by two upper support members.

In a preferred embodiment of the present invention, the electronic coil clip has a metal housing upon which two electromagnetic coils are secured, the coils providing the electromotive driving force to move the needles.

These and other objects, features, and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a side view of a tattooing apparatus according to the present invention;

FIG. 2 is a top view of the tattooing apparatus of FIG. 1;

FIG. 3 is a partially exploded side view of the tattooing apparatus of the present invention according to an alternative embodiment;

FIG. 4 is a top view of the removable coil clip of the tattooing apparatus of the present invention;

FIG. 5 is a cut-away top view of the frame assembly of the present invention with the coil clip removed;

FIG. 6 is a side view of the removable coil clip of the present invention;

FIG. 7 is a side view of the frame assembly of the present invention, including a power switch;

FIG. 8 is a rear view of the removable coil clip of the present invention;

FIG. 9 is a side view of a mono plug for use with the power switch of FIG. 7;

FIG. 10 is a front view of the tattooing apparatus illustrating a needle tensioner;

FIG. 11 is a top view of the tattooing apparatus of the present invention;

FIG. 12 is a side view of the tattooing apparatus of the present invention illustrating the armature bar;

FIG. 13 is a side view of a fully-assembled tattooing apparatus of the present invention; and

FIG. 14 is a side view of another fully-assembled tattooing apparatus of the present invention.

### DETAILED DESCRIPTION AND PREFERRED EMBODIMENT

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

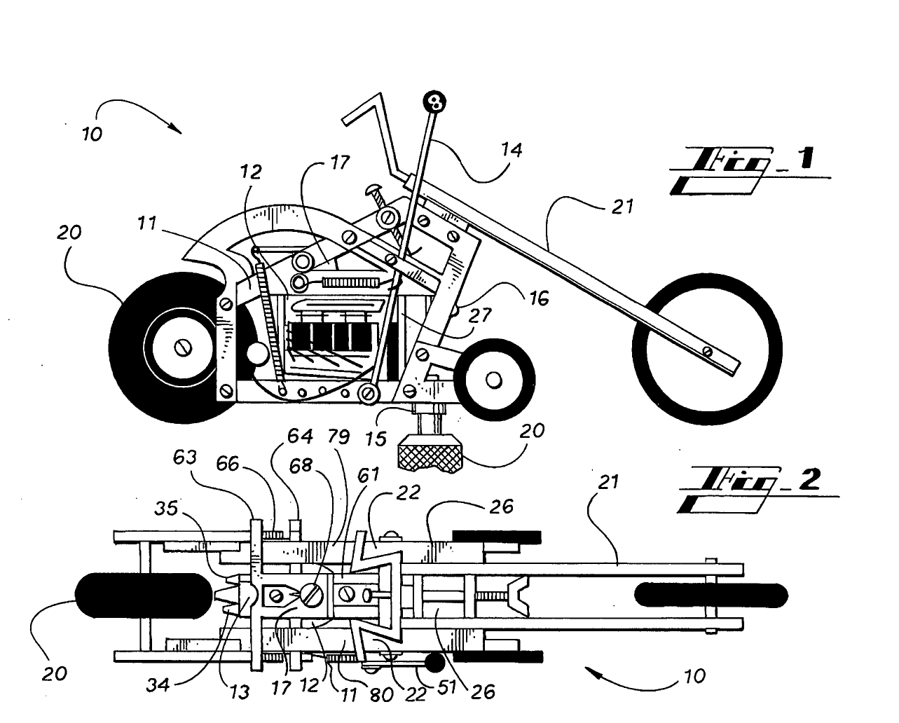

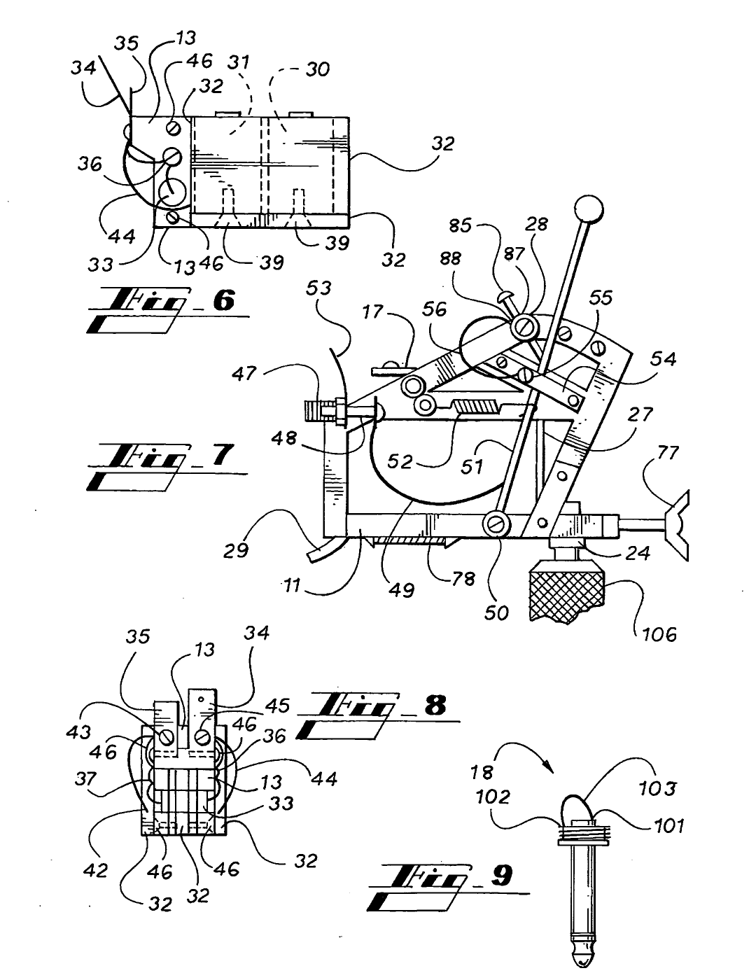

In that form of the preferred embodiment of the present invention chosen for purposes of illustration, FIG. 1 shows tattooing apparatus 10. In the preferred embodiment of the present invention, tattooing apparatus 10 has two main components, frame assembly 11 and coil clip assembly 12, wherein coil clip assembly 12 preferably can be physically detached from frame assembly 11, thereby electrically disconnecting electronic components housed on coil clip assembly 12, preferably via slidable movement coil clip assembly 12 towards the rear of frame assembly 11. When coil clip assembly 12 is physically attached to frame assembly 11, electronic components comprising coil clip 12 are preferably electrically connected to sub-assemblies attached to frame assembly 11, such as power switch 14. Coil clip assembly 12, when physically attached to frame assembly 11, preferably rests on top of base plate 23(FIGURE 5) and behind coil clip protector 27. When coil clip assembly 12 is physically detached from frame assembly 11, frame assembly 11 can be cleaned or disinfected without risk of damaging the electronic components comprising coil clip assembly 12. Furthermore, when coil clip assembly 12 is attached to frame assembly 11, coil clip protector 27 and base plate 23 prevent contamination of coil clip assembly 12, thereby reducing the need to clean or disinfect coil clip assembly 12, which reduces wear on coil clip assembly 12.

Preferably, tube and needle assembly 15, needle tensioner assembly 16, and armature bar assembly 17 are attached to frame assembly 11, wherein the preferred specifics of such attachment is described in detail hereinbelow. Furthermore, rear-end accessories 20 and front-end accessories 21 are shown attached to frame assembly 11, in a decorative arrangement, giving tattooing apparatus 10 a distinctive appearance, such as, for exemplary purposes only, that of a motorcycle, car, or other recognizable object.

Now referring to FIG. 2, frame assembly 11 preferably comprises side plates 22, including left side plate 79 and right side plate 80. Left side plate 79 and right side plate 80 are preferably arranged parallel, and spaced by base plate 23(FIGURE 5) in order to facilitate installation of coil clip assembly 12. It is noted, however, that side plates 22 could be angularly disposed in order to give tattooing apparatus 10 a desired appearance or to facilitate attachment of the sub-assemblies. Furthermore, side plates 22 may be non-planar or vary in thickness, and may optionally included integral features, such as molded features, giving frame assembly 11 the appearance of a recognizable object.

Coil clip assembly 12 preferably comprises circuit board 13, right channel circuit 34, and left channel circuit 35. Circuit board 13 is preferably a double sided circuit board and preferably carries electronic components electrically connected to a power supply by right channel circuit 34 and left channel circuit 35 when the coil clip assembly is attached to frame assembly 11. Power switch 14 preferably comprises shifter 51, wherein manual operation is performed by moving shifter 51 to a first “on” and a second “off” position, thereby respectively completing or breaking the circuit providing power to coil clip assembly 12. Coil clip assembly may be configured in any shape capable of attachment with frame assembly 11, and may include integral features.

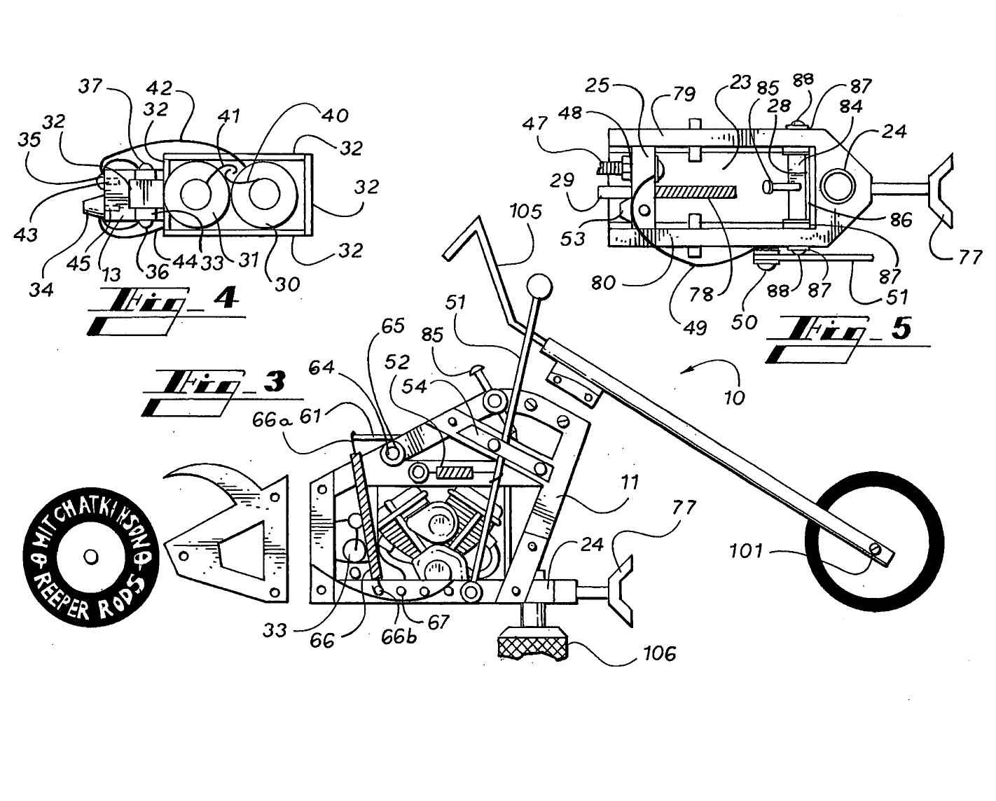

Armature bar assembly 17 preferably comprises armature bar 61, top plate spring adjuster 63, armature bar back axle 64, back armature bar springs 66, and tuning screw 68. Armature bar 61 is preferably mounted on, and pivots around, armature bar back axle 64, wherein armature bar back axle 64 is preferably attached to side plates 22, preferably by back axle c-clips 65 (FIG. 3). Top plate spring adjuster 63 provides a preferred attachment point for first end 66a of back armature bar springs 66, wherein back armature bar springs 66 provide a biasing torque on armature bar 61 around armature bar back axle 64. Tuning screw 68 is preferably attached to armature bar 61 and preferably cooperates with components on circuit board 13, for example front coil 30 or rear coil 31, to adjust the speed of reciprocation of a needle, as discussed in more detail hereinbelow.

Front-end accessories 21 are preferably attached to side plates 22 by front upper removable brackets 26. Front upper removable brackets 26 are preferably adapted to facilitate removal of front-end accessories 21, or replacement of a first style of front-end accessories 21 with a second style of front-end accessories 21, in order to allow customization of the appearance of tattooing apparatus 10.

Now referring to FIG. 3, circuit board 13 preferably carries capacitor 33, and is preferably electrically connected to capacitor 33, thereby electrically connecting capacitor 33 to other electronic components of tattooing apparatus 10. Preferably, an inductance of capacitor 33 determines a performance characteristic of tattooing apparatus 10, such as speed of reciprocation or a driving force of a needle, making tattooing apparatus 10 more appropriate for lining or for shading. Capacitor 33 is preferably attached to circuit board 13, and electrically connected thereto, by removable means, such as screws or clips, in order that capacitor 33 is easily replaceable in the event that it malfunctions and a replacement is needed, or if a new capacitor of a different inductance is desired.

Anchor points 67 provide a plurality of attachment points for second end 66b of back armature bar springs 66. Attachment of second end 66b of back armature bar springs 66 to a selected anchor point 67 provides more or less biasing torque on armature bar 61, depending on which anchor point 67 is selected. Preferably, selection of the anchor point 67 to which second end 66b of back armature bar springs 66 is attached determines a performance characteristic of tattooing apparatus 10, such as the driving force of a needle, and attachment of second end 66b to a different anchor point 67 changes the performance characteristic.

With continued reference to FIG. 3, shifter 51 is preferably disposed within shifter channel 54, and is preferably biased therewithin in an “on” position by shifter spring 52. Contact screw 85 is preferably connected to shifter 51 in the “on” position and preferably forms part of an electrical connection between shifter 51 and circuit board 13, described in greater detail hereinbelow.

Tube and needle assembly 15 (FIG. 1) preferably comprises chuck 24, chuck tightener 77, and tube 106. Chuck 24 and chuck tightener 77 operate to facilitate attachment of tube 106 to frame assembly 11 for use and to facilitate removal of tube 106 during disinfection of frame assembly 11 and/or cleaning or replacing tube 106.

Now referring to FIG. 4, details of preferred coil clip assembly 12 are shown, including housing 32 and circuit board 13. Right channel circuit 34 and left channel circuit 35 are preferably physically attached and electrically connected to circuit board 13, bolt 43, and bolt 45. Capacitor 33 is also preferably physically attached to circuit board 13 by right capacitor screw 36 and left capacitor screw 37, and preferably is electrically connected to right channel circuit 34 and left channel circuit 35 by wires. Front coil 30 and rear coil 31 are preferably mounted inside housing 32 by screws 39 (FIG. 6). Front coil 30 preferably has front coil outside wire 42 electrically connected to left channel circuit 35 and front coil inside wire 40 connected to rear coil inside wire 41. Rear coil 31 also preferably has rear coil outside wire 44 connected to right channel circuit 34.

As discussed above, capacitor 33 can easily be removed by removing both right capacitor screw 36 and left capacitor screw 37, whereby another capacitor can be connected in its place. Furthermore, housing 32 is designed to slidably engage with frame assembly 11, including side plates 22, base plate 23 (FIG. 5), and coil clip protector plate 27 (FIGS. 1 and 7).

FIG. 5 shows base plate 23, preferably defining the bottom of frame assembly 11, attaching left side plate 79 to right side plate 80. Preferably, back bracket 25 also attaches left side plate 79 to right side plate 80. Back bracket 25 preferably carries back binding post 48 and back binding post spring 47. Back binding post 48 and back binding post spring 47 preferably provide electrical connection to left channel circuit 35 when coil clip assembly 12 is attached to frame assembly 11. Also connected to back binding post 48 is lower binding post wire 49, which electrically connects back binding post 48 to shifter 51 by way of shifter mounting screw 50. Electrode 53 is preferably attached to back bracket 25, and provides an electrical connection with right channel circuit 34 when coil clip assembly 12 is attached to frame assembly 11.

Front binding post 28 is preferably attached to left side plate 79 and right side plate 80 by grommets 87, which provide electrical insulation, and front binding post screws 88. Contact screw 85 is preferably disposed in contact screw chuck 84 and retained therein by contact screw tightener 86. Contact screw chuck 84 preferably provides electrical connection between contact screw 85 and front binding post screws 88.

Trigger 29 is preferably attached to base plate 23 and trigger spring 78. Trigger spring 78 preferably provides a biasing force to the trigger that holds coil clip assembly 12 attached to frame assembly 11 until trigger 29 is operated optionally, back binding post spring 47 may be configured to eject coil clip assembly 12 from frame assembly 11 when trigger 29 is operated. While trigger 29 is preferred, any suitable means for releasably attaching coil clip assembly 12 to frame assembly 11 may be used. Furthermore, any suitable means for selectively releasing coil clip assembly 12 from attachment to frame assembly 11, such as a button, level, pin, or other mechanical means, or electronic means may be used.

Now referring to FIG. 6, circuit board 13 is preferably attached to housing 32 of removable coil clip assembly 12 by bolts 46. Front coil 30 and rear coil 31 are likewise preferably attached to housing 32 by screws 39. While bolts 46 and screws 39 are preferred, other means of attachment could be utilized, such as, for exemplary purposes only, rivets, welds, clips, hooks or any other suitable means.

Rear coil outside wire 44 is preferably attached to right channel circuit 34 providing electrical connection to rear coil 31. Also, capacitor 33 is preferably attached to circuit board 13 by right capacitor screw 36, providing electrical connection to right channel circuit 34. Finally, right channel circuit 34 and left channel circuit 35 preferably extend away from housing 32 and are adapted to make electrical contact with electrode 53 and back binding post spring 47, respectively, although any means of achieving electrical connection between coil clip assembly 12 and frame assembly 11 may be used.

FIG. 7 shows frame assembly 11 with coil clip assembly 12 removed, wherein trigger 29 and trigger spring 78 preferably project below frame assembly 11, and are preferably accessible to the tattooist, and operable to eject coil clip assembly 12. Back binding post 48 and back binding post spring 47, along with electrode 53, preferably project outwardly from frame assembly 11 wherein back binding post spring 47 and electrode 53 preferably contact left channel circuit 35 and right channel circuit 34, respectively, when coil clip assembly 12 is attached to frame assembly 11.

Power switch 14 preferably comprises shifter 51, shifter spring 52, shifter channel 54, circuit screw connector 55, and front binding post wire 56. Power switch 14 preferably operates by manipulation of shifter 51 to one of an “on” and an “off” position within shifter channel 54, thereby respectively making or breaking an electrical connection between back binding post 48 and front binding post 28. Shifter channel 54 is preferably made of an electrically insulating material to prevent creation of a short circuit. While shifter 51 is preferred, any electrical switch means may be used to selectively activate tattooing apparatus 10.

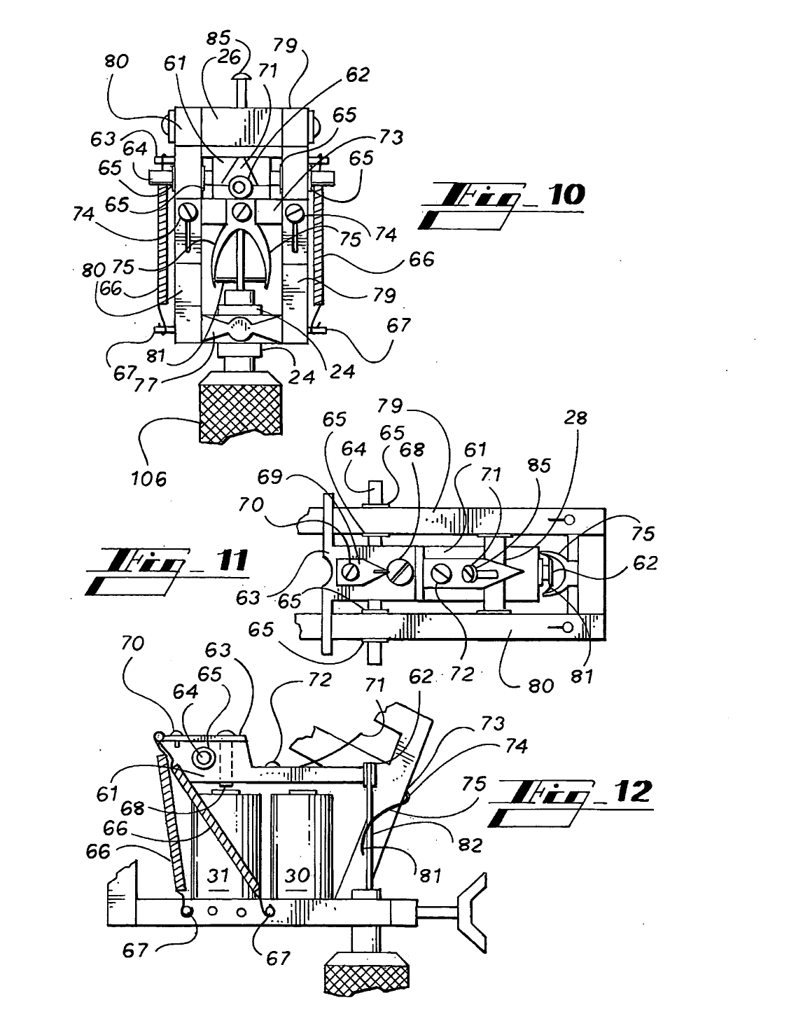

Now referring to FIG. 8, a rear view of removable coil clip assembly 12 is shown, wherein right channel circuit 34 and left channel circuit 35 preferably project above housing 32 and are preferably attached to circuit board 13 by bolt 43 and bolt 45. Also, circuit board 13 is preferably attached to housing 32 by bolts 46, and connected to capacitor 33 by right capacitor screw 36 and left capacitor screw 37. While bolts 43, 45, and 46, and screws 36 and 37 are preferred, any suitable attaching means may be used, including, but not limited to, rivets, welds, clips, hooks, or any other suitable means.

Now referring to FIG. 9, modified mono plug 18 preferably includes a direct electrical connection 103 between inside electrode 101 and outside electrode 102, thereby eliminating a circuit that would conventionally be connected to a foot pedal switch. According to the present invention, a foot pedal switch is unnecessary due to power switch 14. According to an alternative configuration, however, a foot pedal could be used with a traditional mono plug without departing from the scope of the present invention.

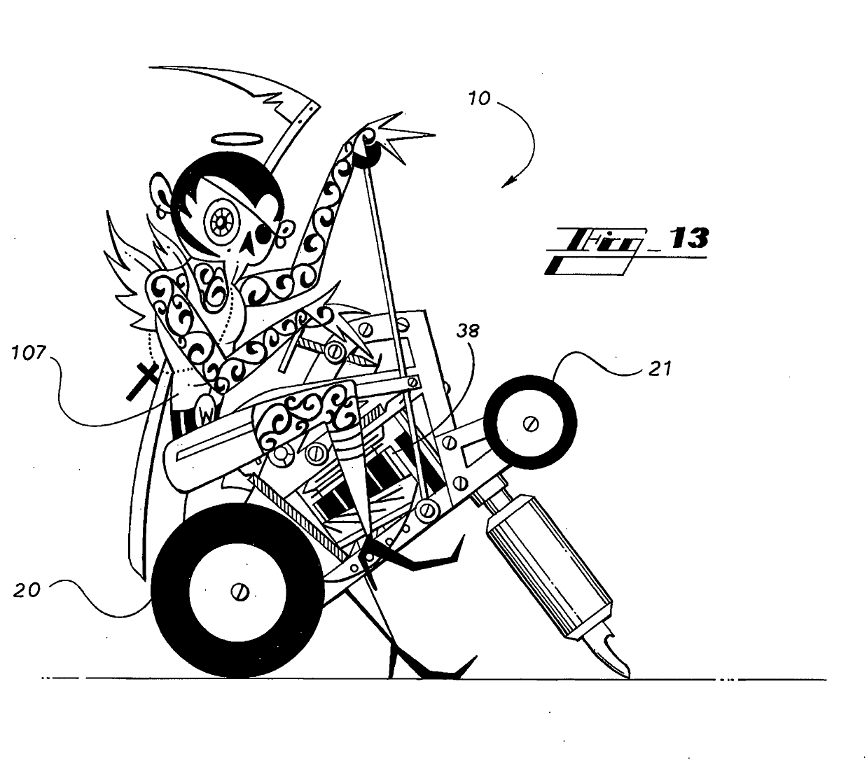

Now referring to FIG. 10, needle and tube assembly 15 preferably includes needle tensioner frame 73, preferably attached to left side plate 79 and right side plate 80 by needle tensioner screws 74. Needle tensioner frame 73 also preferably carries wishbone bracket 75. Wishbone bracket 75 preferably works in conjunction with band 81 to provide a side force on needle 82 thereby causing a frictional resistive force to a vertical motion of needle 82 within tube 106. Needle tensioner frame 73 can preferably be adjusted along side plates 22 by adjustment of needle tensioner screws 74 in order to cause more or less resistive force to the vertical motion of the needle 82, thereby allowing for selective adjustment of a performance characteristic of tattooing apparatus 10, such as the driving force on the needle.

FIG. 11 shows armature bar back axle 64 attached to left side plate 79 and right side plate 80 via preferred back axle c-clips 65. Armature bar 61 is preferably attached to armature bar back axle 64 and preferably carries tuning screw 68, tuning screw lock 69, and lock screw 70. Lock screw 70 preferably screws into armature bar 61 to retain tuning screw lock 69 in a position engaging slots or grooves in tuning screw 68, thereby preventing unwanted rotation of tuning screw 68. Front spring 71 is preferably attached to armature bar 61 by front spring screw 72. Front spring 71 preferably projects from armature bar 61 such that electrical contact is made with contact screw 85 when armature bar 61 is in a first position. Finally, nipple 62 is preferably attached to the front of armature bar 61 and preferably retains needle 82 in a fixed position relative to armature bar 61.

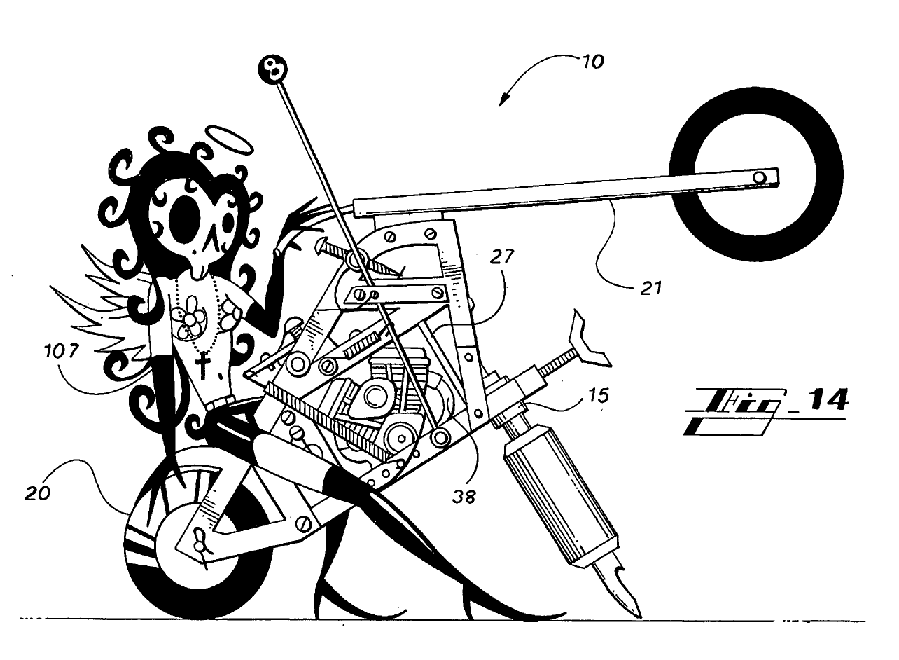

FIG. 12 shows armature bar 61 in the first position, related to front coil 30 and rear coil 31. Preferably, when front spring 71 makes electrical contact with contact screw 85, electric current flow through front coil 30 and rear coil 31, creates an electromagnetic field to attract armature bar 61, causing rotation of armature bar 61 around armature bar back axle 64, to place armature bar 61 in a second position. In the second position, front spring 71 is preferably not in contact with contact screw 85, whereby the electromagnetic field dissipates, and the biasing force of armature bar spring 66 preferably causes armature bar 61 to rotate back to the first position. This cycle repeats as long as tattooing device 10 is connected to a source of electric potential, and a complete circuit is otherwise present, such as shifter 51 being in the “on” position. Preferably, the distance between tuning screw 68 and front coil 30 or rear coil 31 affects the speed of reciprocation of the needle 82, wherein greater distance decreases needle reciprocation speed and lesser distance increases needle reciprocation speed. The distance is preferably adjusted by turning tuning screw 68, although other suitable structure for adjusting the distance may optionally be used. Preferably, when the distance between tuning screw 68 and front coil 30 or rear coil 31 is smaller, the speed of reciprocation is higher, and when the distance between tuning screw 68 and front coil 30 or rear coil 31 is greater, the speed of reciprocation is lower.

Now referring to FIG. 13 and FIG. 14, tattooing apparatus 10 preferably includes rear-end accessories 20, front-end accessories 21, and figurine 107. As shown in FIG. 13, rear-end accessories 20 and front-end accessories 21 give tattooing apparatus 10 an appearance of a hot-rod. As shown in FIG. 14, rear-end accessories 20 and front-end accessories 21 give the tattooing apparatus an appearance of a motorcycle. Artwork 38 can optionally be included in the form of a sticker or decal, or can be painted on tattooing apparatus 10 in order to add to the appearance of the tattooing apparatus. Such an appearance allows a tattooist to customize tattooing apparatus 10 to suit their taste, and to aid in identifying a particular tattooist's tattooing apparatus 10 as their own. Furthermore, tube and needle assembly 15 can be removed and the tattooing apparatus 10 can be used as a toy motorcycle or hot-rod depending on the configuration of rear-end accessories 20 and front-end accessories 21 that are attached. One skilled in the art should readily recognize that the accessories depicted and described are exemplary only and are not intended to limit potential accessories or artistic configurations that may be utilized.

In use, the tattooist may begin with clean and sterilized components fully assembled and adjusted for a lining operation. The tattooist can initiate operation of tattooing device 10 by operating shifter 51 and can commence creating an outline of a tattoo on a client's body. Throughout the lining operation, the electronic components on coil clip assembly 12 remain clean and do not come into contact with any potential contaminants due to the preferred arrangement of coil clip assembly 12 shielded from the tattoo site by protector plate 27 and bottom plate 23. When the lining operation has been completed, the tattooist can turn off tattooing apparatus 10 by operating shifter 51 and either adjust tattooing apparatus 10 for a shading operation, for example, by adjusting tuning screw 68 to increase the distance between tuning screw 68 and front coil 30 or rear coil 31, or operate trigger 29, thereby ejecting coil clip assembly 12 and to insert another coil clip assembly that is adjusted for a shading operation, for example, including coils with fewer turns. Once adjusted, the tattooist can turn on tattooing apparatus 10 and commence filling in the outline or shading portions of the tattoo. The tattooist can adjust tattooing apparatus 10 for a lining or shading operation, or switch coil clip assemblies to achieve the adjustment, as many times as is necessary to complete the desired tattoo image. Once completed, the tattooist can eject coil clip assembly 12 in order to clean and/or disinfect tattooing apparatus 10.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A tattooing apparatus comprising:
a frame assembly;
at least one connector attached to said frame assembly;
a removable coil clip assembly adapted to engage said at least one connector; and
an ejector adapted to selectively retain said coil clip engaged to said at least one channel circuit.

2. The tattooing apparatus of claim 1, wherein operation of said ejector releases said removable coil clip from engagement with said at least one connector such that said removable coil clip can be removed from said tattooing apparatus.

3. The tattooing apparatus of claim 1, further comprising a switch assembly attached to said frame assembly and operatively connected to said tattooing apparatus, wherein said switch assembly selectively supplies power to said tattooing apparatus.

4. The tattooing apparatus of claim 1, wherein said frame assembly comprises a first side plate, a second side plate, and attachment means, said second side plate arranged parallel to and spaced from said first side plate, and said first side plate and said second side plate attached by said attachment means.

5. The tattooing apparatus of claim 4, wherein the frame assembly further comprises a coil clip protector plate arranged between said coil clip and a needle assembly.

6. The tattooing apparatus of claim 1, further comprising a tuner, wherein said tuner selectably adjusts a speed of reciprocation of a needle of said tattooing apparatus.

7. The tattooing apparatus of claim 1, further comprising an armature bar adjustably connected to said frame assembly and operatively connected to a needle of the tattooing apparatus, wherein said armature bar selectively adjusts a driving force of a needle of said tattooing apparatus.

8. A tattooing apparatus comprising:
a frame assembly;
at least one channel circuit attached to said frame assembly;
a removable coil clip assembly adapted to engage said at least one channel circuit; and
a tuner operatively connected to said removable coil clip assembly;
wherein said tuner selectively adjusts a speed of reciprocation of a needle of said tattooing apparatus.

9. The tattooing apparatus of claim 8, further comprising a switch assembly attached to said frame assembly and operatively connected to said tattooing apparatus, wherein said switch assembly selectively supplies power to said tattooing apparatus.

10. The tattooing apparatus of claim 8, wherein said frame assembly comprises a first side plate, a second side plate, and attachment means, said second side plate arranged parallel to and spaced from said first side plate, and said first side plate and said second side plate attached by said attachment means.

11. The tattooing apparatus of claim 10, wherein the frame assembly further comprises a coil clip protector plate arranged between said coil clip and a needle assembly.

12. The tattooing apparatus of claim 8, further comprising a spring loaded trigger adapted to selectively retain said coil clip engaged to said at least one channel circuit, whereby operation of said spring loaded trigger releases said removable coil clip from engagement with said at least one channel circuit such that said removable coil clip can be removed from said tattooing apparatus.

13. The tattooing apparatus of claim 8, further comprising an armature bar adjustably connected to said frame assembly and operatively connected to a needle of the tattooing apparatus, wherein said armature bar selectively adjusts a driving force of a needle of said tattooing apparatus.

14. A tattooing apparatus comprising;
a frame assembly;
at least one channel circuit attached to said frame assembly;
a removable coil clip assembly adapted to engage said at least one channel circuit; and
an armature bar adjustably connected to said frame assembly and operatively connected to a needle of the tattooing apparatus;
wherein said armature bar selectively adjusts a driving force of a needle of said tattooing apparatus.

15. The tattooing apparatus of claim 14, further comprising a switch assembly attached to said frame assembly and operatively connected to said tattooing apparatus, wherein said switch assembly selectively supplies power to said tattooing apparatus.

16. The tattooing apparatus of claim 14, wherein said frame assembly comprises a first side plate, a second side plate, and attachment means, said second side plate arranged parallel to and spaced from said first side plate, and said first side plate and said second side plate attached by said attachment means.

17. The tattooing apparatus of claim 16, wherein the frame assembly further comprises a coil clip protector plate arranged between said coil clip and a needle assembly.

18. The tattooing apparatus of claim 14, further comprising an ejector adapted to selectively retain said coil clip engaged to said at least one channel circuit, whereby operation of said ejector releases said removable coil clip from engagement with said at least one channel circuit such that said removable coil clip can be removed from said tattooing apparatus.

19. The tattooing apparatus of claim 14, further comprising a tuner operatively connected to said removable coil clip assembly, wherein said tuner selectably adjusts a speed of reciprocation of a needle of said tattooing apparatus.

20. A tattooing apparatus comprising:
a frame assembly; and
at least one of front end accessories attached to said frame assembly and rear end accessories attached to said frame assembly;
wherein said at least one of front end accessories and rear end accessories gives said tattooing apparatus an appearance of at least one of a car and a motorcycle.

21. A method of disinfecting a tattooing apparatus comprising the steps of:
operating a trigger of said tattooing apparatus in a first state to release a removable coil clip assembly from at least one channel circuit of said tattooing apparatus;
removing said removable coil clip assembly from said at least one channel circuit, thereby physically decoupling said removable coil clip assembly from said tattooing apparatus and placing said tattooing apparatus in a second state;
disinfecting said tattooing apparatus in said second state; and
replacing said removable coil clip assembly from in said at least one channel circuit, thereby physically coupling said removable coil clip assembly with said tattooing apparatus and placing said tattooing apparatus in said first state.

22. The method of claim 20, wherein said coil clip assembly comprises electronic components, and said step of removing said removable coil clip assembly protects said electronic components by preventing exposure of said electronic components to a disinfectant during the step of disinfecting said tattooing apparatus.
